(19) United States
(12) Patent Application Publication
(10) Pub. No.: US 2010/0312619 A1
(43) Pub. Date: Dec. 9, 2010

(54) METHOD AND A SYSTEM FOR PROVIDING MOBILE COMMUNICATIONS SERVICES

(76) Inventors: Pekka Ala-Pietila, Helskinki (FI); Antti Ohrling, London (GB)

Correspondence Address: LUCAS & MERCANTI, LLP, 475 PARK AVENUE SOUTH, 15TH FLOOR, NEW YORK, NY, 10016, US

(21) Appl. No.: 12/601,149

(22) PCT Filed: Mar. 27, 2008
(86) PCT No.: PCT/IB08/02897

§ 371 Date: Jul. 13, 2010

Related U.S. Application Data
(60) Provisional application No. 60/931,336, filed on May 23, 2007.

(51) Int. Cl. G06Q 30/00

(52) U.S. Cl. 705/14.1

(57) ABSTRACT

An advertisement system of a mobile services operator manages advertising campaigns and comprises a database that contains all relevant information for advertisement campaigns to be run. Marketing messages are delivered to mobile users via a communication network. The mobile services operator provides mobile communications services for the mobile users in return of receiving the marketing messages. The communications services and the marketing messages are billed from advertisers.

### CROSS-REFERENCE TO RELATED APPLICATION

This application claims the benefit of the filing date of U.S. Provisional Patent Application Ser. No. 60/931,336 filed May 23, 2007, the entire disclosure of which is incorporated herein by reference.

### FIELD OF THE INVENTION

The invention relates to communications systems, and particularly to a method and a system for providing mobile communications services.

### BACKGROUND OF THE INVENTION

Mobile marketing is considered by advertisers as the next new channel to reach direct to the user by utilizing the core assets and characteristics of the mobile media: it being personal, “always on”, mobile and naturally forming groups of people who communicate actively with each other. These characteristics combined with social networks—based marketing approach of the Internet could form a very powerful base to execute marketing strategies.

In general, mobile marketing and advertising can be divided into the following four categories:
a) Mobile Marketing: The systematic planning, implementing and control of a mix of business activities intended to bring together buyers and sellers for the mutually advantageous exchange or transfer of products where the primary point of contact with the consumer is via their mobile device.
b) Mobile Advertising: The paid, public, non-personal announcement of a persuasive message by an identified sponsor; the non-personal presentation or promotion by a firm of its products to its existing and potential customers where such communication is delivered to a mobile phone or other mobile device. Examples of mobile advertising would include: Wireless Application Protocol (WAP) Banner ads, Web page Banner ads, mobile search advertising, mobile video bumpers, and interstitial ads in on device portals.
c) Mobile Direct Marketing: Sales and promotion technique in which the promotional materials are delivered individually to potential customers via the potential customer's mobile phone or other mobile device. Examples of mobile direct marketing include the sending of Short Message Service (SMS), Multimedia Message Service (MMS) or WAP push messages, Bluetooth messaging, personalized WAP and Web page banner and other advertisements and other interrupt based marketing to mobile phones or other mobile devices.
d) Mobile customer relation management (CRM): Combination of all the above in a manner that establishes a long-term, engaging relationship between the customer and the promoting company.

Today's mobile marketing is usually mostly based on push campaigns to opt-in consumer mobile number database, or pull campaigns that acquire mobile phone numbers from consumers. The most typical example of the pull campaign is the “text-to-win” campaign were, e.g., a soft drink bottle contains a short code to be sent via text message to the certain number. In return, the consumer receives a notification if they have won with the selected marketing message or series of messages being broadcasted to their mobile phones. Another popular method is direct advertisement done using text and picture messaging.

Consumers' willingness to receive and respond to advertisements or marketing messages in mobile environment is limited due to fact that they are already paying for the mobile service. In many situations the receiving of marketing information via a mobile channel is considered as a burden by these consumers leading to a dilution of the mobile marketing channel in respect to the brand owners.

There have been attempts to provide marketing messages in conjunction with extra benefits to consumers. Typically these are offered on the top of an existing mobile service thus generating extra complexity to the consumers by requiring to sign up to a separate service. Some of the mobile advertisement services, such as a banner advertisement in the WAP pages, are technically arranged in such a way that those actually generate more cost for the consumers in form of increased data cost than benefit of marketing message causing customer dissatisfaction.

### SUMMARY OF THE INVENTION

In accordance with the aspects of the invention, there is provided a method and a system for providing mobile communications services.

According to an aspect of the invention, a method for providing mobile communications services comprises
making a subscription agreement between a service provider and a plurality of users on free or subsidized mobile communications services,
collecting a user profile for each of said plurality of users, each user profile profiling a user for marketing purposes,
making an agreement between the service provider and at least one advertiser on delivering advertisement messages,
selecting target users for said advertisement messages among said plurality of users based on said collected user profiles,
delivering said advertisement messages to said target users through a mobile communications network,
providing said target users with free or subsidized mobile communications services in the mobile communications network as a reward for receiving and/or reacting to said advertisement messages,
financing the service operator by revenues from the at least one advertiser.

According to another aspect of the invention, a mobile communications service provider system comprises
a database configured to store a user profile for each of a plurality of users having a subscription agreement between a service provider and a plurality of users on free or subsidized mobile communications services, each user profile profiling a user for marketing purposes,
an advertisement management unit configured to manage advertisement messages or campaigns according to an agreement made between the service provider and at least one advertiser on delivering advertisement messages, revenues from the at least one advertiser financing the operation of the mobile communications service provider system,
an advertisement gateway configured to deliver advertisement messages through a mobile communications network to target users selected for said advertisement messages among said plurality of users based on said collected user profiles, and
a billing system configured to provide said target users with free or subsidized mobile communications services in the mobile communications network as a reward for receiving and/or reacting to said advertisement messages.

According to a further aspect of the invention, a computer readable storage medium, comprising program code which, when run on a computer system, causes execution of a procedure comprising
storing a user profile for each of a plurality of users having a subscription agreement between a service provider and a plurality of users on free or subsidized mobile communications services, each user profile profiling a user for marketing purposes,
managing advertisement messages or campaigns according to an agreement made between the service provider and at least one advertiser on delivering advertisement messages, revenues from the at least one advertiser financing the operation of the mobile communications service provider system,
delivering advertisement messages through a mobile communications network to target users selected for said advertisement messages among said plurality of users based on said collected user profiles, and
providing said target users with free or subsidized mobile communications services in the mobile communications network as a reward for receiving and/or reacting to said advertisement messages.

### BRIEF DESCRIPTION OF THE DRAWINGS

In the following the invention will be described in greater detail by means of exemplary embodiments with reference to the attached drawings, in which

FIG. 1 is a block diagram illustrating a high-level architecture of an exemplary communications system wherein the concepts of the present invention may be implemented;

FIG. 2 is a block diagram illustrating another example of a communications system wherein the concepts of the invention may be implemented;

FIG. 3 is a block diagram illustrating an example of an advertisement management system; and

FIG. 4 is a flow chart illustrating an exemplary concept of providing subsidized mobile communications services to users or consumers in accordance with an aspect of the invention.

### DETAILED DESCRIPTION OF THE INVENTION

In the Figures, same references symbols refer to similar structures or functions.

FIG. 4 illustrates an exemplary concept that enables a mobile communications service provider to provide free or subsidized mobile communications services to users or consumers in an economically feasible way.

In the exemplary concept, the mobile communications service provider or operator is referred to as a Commercial Virtual Operator (CVO) 402 and the service concept is referred to as a Commercial Virtual Operator Network (CVON). The CVO is a virtual operator in a sense that while the users experience the CVO as a normal network operator, the CVO may not necessarily have got any mobile communications network of its own but it may lease or hire part or all of the required mobile network resources from a mobile communications network of another network operator 404 for business purposes of building a virtual operator which offers free or subsidized mobile communications services. As another approach, the example concept according to the invention may be run as a non-virtual operator model as well, so that all or some of the mobile communications network are owned by a party interested in offering free or subsidized mobile services for consumers. Example of such party could be a cellular operator/carrier who wants to build a sub-brand (a virtual network) or a special subscription model focusing on advertisement offerings. As another approach for CVO could be usage of any carrier (404) network as transport for the data, messaging and calls. In this type of arrangement CVO could offer services for any user of any network. As used herein the terms Commercial Virtual Operator (CVO) and Commercial Virtual Operator Network (CVON) are intended to refer any mobile communications service provider or operator providing free or subsidized mobile communications services, regardless of the ownership of various networks and network elements involved or regardless of the relations of various operators involved.

Referring to the exemplary concept shown in FIG. 4, a Commercial Virtual Operator CVO 402 may make an agreement (410) with a network operator 404 defining terms and conditions for using cellular mobile network resources for offering the CVON mobile services for consumers. For example, the CVO may be charged based on usage of the network resources such as voice and data and messaging. As another example, the network operator may receive a share of the revenue from the advertisements sent in return of the use of the network resources. Upon making the agreement, the network operator 404 allows the CVO to use the cellular network resources (412). Naturally, such agreement may not be needed, if the network resources and the CVON are owned by the same party. Such agreements may not also be needed if CVO services are offered in top of consumers 406 agreement with their current carrier (such as party offering mobile services using 404).

A subscription agreement 414 may be made between the CVO 404 and a plurality of users or consumers 406 on free or subsidized mobile communications services in return of receiving marketing messages. The agreement 414 may include terms and conditions defining how many advertisements per time period the consumers have to receive, which messages they have to respond to, etc. An example of the number of advertisements per day may be 4 short messages (SMS) or multimedia messages (MMS) per day 7 days per week. An example of mobile communications services offered in return to consumer may be 100 minutes of voice service and 200 text messages and some data services. Technically the mobile communication services may be provided and the advertising messages delivered (416) via network operator's 404 network to consumers.

The free or subsidized mobile communications services offered as a reward to the users or consumers may be provided before, during and/or after said target users receive and/or react to the advertisement messages. The reward may be provided to the user in a single action or in a plurality of actions. Rewards given before receiving/reacting to advertisements may be different than rewards given after receiving/reacting to advertisements. A first reward may be a reward for joining/completing a subscription agreement. A reward given during receiving/reacting to advertisements may a free or subsidized communication or service relating to an advertisement, for example. The CVON may cancel (bill/charge afterwards) free or subsidized mobile communications services given beforehand if a user fails to meet the terms and conditions, e.g. receive or react to a predetermined number of advertisement messages.

Advertisers and brand owners 408 may make agreements 418 directly or via agent with the CVO. The agreement 418 is to deliver marketing messages to target consumers.

Advertisers 408 may pay (420) for the services of message delivery to the CVO. Payment fees 420 may include delivery cost of the actual message, profiling cost of the messages, monthly payments, profit margin of the CVO, etc.

Typically the rationale of advertiser or brand owner 408 to advertise to consumers 406 is that there is possibility that the consumers will purchase goods or services (422) that are marketed to the consumers, and that there is a possibility to get feedback on the advertised products using the interactive nature of the mobile channel.

There may be a set of different type of advertisement types offered by the CVON 402 to advertisers 408. These may include but are not limited to
1) Multimedia message service (MMS) based advertisements. In these advertisements there is typically picture and/or text and/or video and/or audio presentation sent to a consumer 406 using an MMS channel of the mobile network. The advertisement may or may not include interaction part, such as a link or request for response as part of the message. In an embodiment of the CVON concept, the advertisement that generates responses from the consumers 406 may be priced with a higher price from the advertiser 408 due to the added value of the response from the consumers 406. Technically MMS messages have all standard SMIL (Synchronized Multimedia Integration Language) controls included. Responses from the consumers 406 may be provided via an MMS or SMS system, or by a click thru operation via links provided in an advertisement message. Typically, MMS content formats are adapted to a target terminal prior to sending an advertisement message. Content formatting can be done dynamically as needed or there might be a set of ready-made formats for each or some of target terminal types.
2) Short message service (SMS) based advertisements. In these advertisements the message is typically a text message. The message can be one message with 160 characters or less, or a concatenated message consisting of two or more text messages of 160 characters. A response to an SMS advertisement may be done by means of a SMS message, an MMS message or a click-thru operation from a consumer 406. An advertisement message may be a normal SMS or a flash message or it may be a data message including a logo or a ringing tone.
3) Message tagging based advertisement. In this group of advertisements the communication between two or more members (e.g. consumers 406) in the CVO network, or between a member of the CVON and other subscriber in other network, is tagged with an advertisement. In practice this may refer to adding advertising information in the message to be tagged, typically at the end of the message. The tagged information may be related to the content communicated between subscribers, or the tagged information may be related to member profiles of a sender and/or a receiver of the communication, or it can be random or selected by the advertiser 408. The extra tagged information part of the message may be indicated to a consumer 406 by adding a special character or a group of characters between the original message content and advertisements, such as “̂”.
4) WAP push based advertisement may relate to sending a wireless application protocol (WAP) link to a consumer 406. The link may be, for example, a free link for the consumer 406. This may be implemented such that certain traffic to certain target URLs is set to be free for the consumer 406, or masking the target URL with a CVON URL. Alternatively links may be sent as part of an MMS or SMS message. The links in these examples may also be free or partly free for the consumer 406 using the same or similar implementation.
5) Banner advertisements. As the consumer 406 browses on web or WAP sites, there may be a set of banner advertisements added to the retrieved pages by the CVON. Alternatively, the banner advertisements may be added by a 3^{rd} party or a site owner or another party
6) Search related advertisements. One additional business opportunity for a marketing funded operator 402 is to include sponsored links to search results obtained in reply to a mobile search (e.g. with a search engine, such as Google) performed by a consumer 406. Some of the sponsored links may be free or subsidized to access by a consumer 406.
7) Interactive ads. Interactive advertisements refer to any advertisements which might have an interactive part embedded in the advertisement message. These advertisements may contain a group or chain of advertisements that are sent upon receiving an answer or a desired interaction to a first advertisement.

The above list describes only in high level the functionality of exemplary advertisement possibilities that may be offered with the CVON concept to advertisers 408. There may also be, for example, video, audio, etc. type of advertisements provided by the CVON. From the business point of view, it must be noted that typically more than one of the advertisement types are offered to advertisers in order to offer a comprehensive enough portfolio of tools for the advertisers 408 to create innovative advertisement campaigns, and for the CVO 402 to attract sufficient revenues from the advertisers 408 to be able to offer free mobile service for consumers 406.

The CVON type of system is preferably run in a day-to-day manner in such a way that the revenues from advertisers 408 is sufficient to cover cost of operations and cost of leasing or running the cellular network. Typically this may require a set of direct sales force but the advertisement system of the CVO may also have a self-service interface for the advertisers 408 to define and modify the advertisements and make order of the campaign without any or with only a limited amount of direct sales force. There may also be a method of limiting the number of members (customer 406) which are allowed to join the free service, in order to control the business risk of offering free services if there is not sufficient amount of advertisements in.

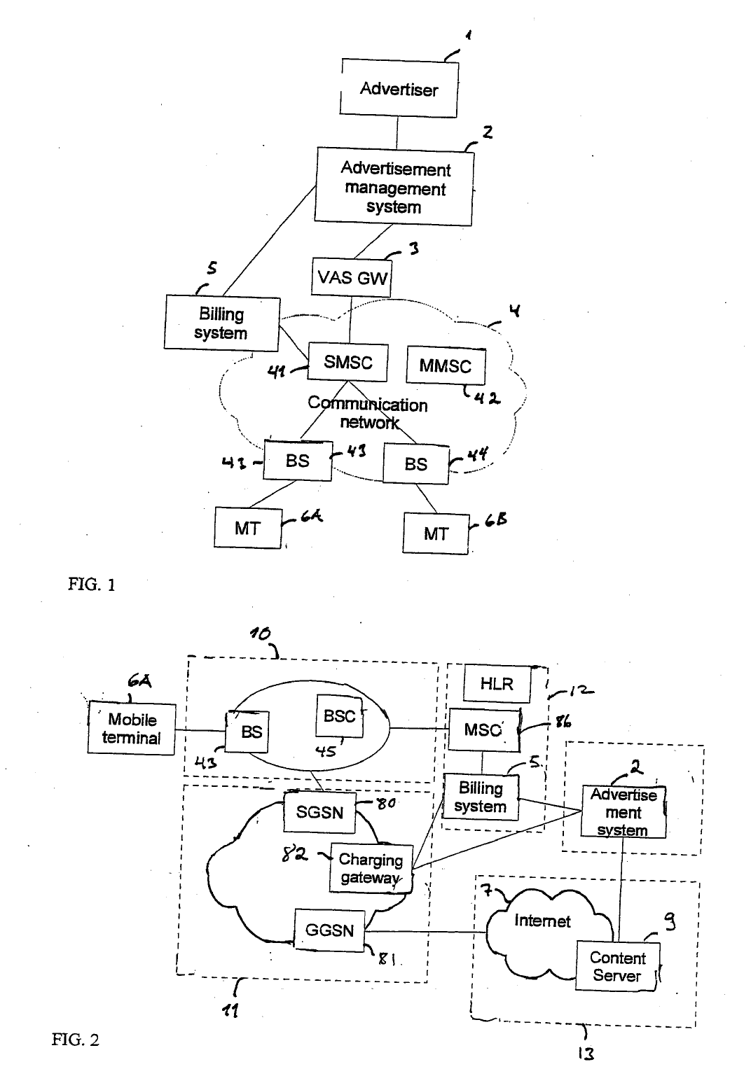

FIG. 1 is a block diagram illustrating a high-level architecture of an exemplary communications system wherein the concept according to FIG. 4 may be implemented. Reference numeral 6 denotes a mobile terminal. The mobile terminal 6 may be a mobile phone, a personal digital assistant (PDA), a multimedia computer, a personal computer, a lap top, etc., or generally any terminal capable of access in services, such as content download, web browsing, streaming, Wireless Application Protocol (WAP) browsing, voice and messaging.

An advertiser 1 (corresponds to the advertiser 408 in FIG. 4) may be any party that wants to provide messages to consumers for advertising products or services to customer, such as a brand owner, a service provider, an advertisement agent, or a merchant. There may be a plurality of advertisers. The advertiser may reserve, program, and/or book a campaign via a web interface from advertisement management system 2, for example. Messages may be commercial, such as product or service promotion, or non-commercial messages, such as general information services. The advertiser 1 may provide advertisement messages in form of, for example, data, text, pictures, audio, video, links, Hypertext Markup Language (HTML), Extensible Markup Language XML, and/or Extensible Hypertext Markup Language (XHTML) to an advertisement management system 2. The advertiser 1 may also provide preferences of the campaign or advertisement, such as: when to send messages, to which target group, on which format, a target price level of the advertisement, a target feedback level of the advertisement, demographics of the target audience, a duration of the advertisement campaign.

The advertisement system 2 manages advertising campaigns and may comprise an advertisement database that may contain all relevant information for the advertisement campaign to be run. The advertisement management system 2 may also have tools for the advertiser 1 to define a campaign so that all or some of campaign parameters and the rules may be set, cancelled, modified, updated, or otherwise processed by the advertiser 1. The advertisement management system 2 may be used to keep and maintain rules of the sponsoring of access to web services for the users.

The advertisement is delivered to users 6A and/or 6B via communication network 4. The communication network 4 can be any cellular, broadcast, wide area, local area network or the Internet. Examples of cellular network technologies include but are not limited to GSM (Global System for Mobile communication), WCDMA (Wideband CDMA), CDMA (Code Division Multiple Access), GPRS (General Packet Radio Service), UTRAN (UMTS Radio Access Network), UMTS (Universal Mobile Telecommunications System), MBMS (Multicast Broadcast Multimedia System). Examples of other network technologies include but are not limited to local area networks, such as Wireless Local area networks (WLAN), BlueTooth (BT), and other technologies, such as WiMax (Worldwide Interoperability for Microwave Access), Broadcasting over cellular, Broadcasting over DVB-H (Digital Video Broadcasting-Handhelds), ISDB-T (Terrestrial Integrated Services Digital Broadcasting), DMB (Digital Multimedia Broadcasting). The communication network 4 may also be provided by any generic Internet access using any transport methods. The communication network 4 can be also a combination of different communication network technologies.

In the example of FIG. 1, the communication network 4 comprises a cellular network is shown with exemplary network elements, such as base stations (BSs) 43 and 44, a Short Message Service Center (SMSC) 41 and a Multimedia Message Service Center (MMSC) 42.

There may also be provided a value added service gateway (VAS GIN) 3 that connects the communication network 4 or some of the elements thereof to the advertisement management system 2. The VAS gateway 3 may also be connected to a billing system 5. The VAS gateway 3 may include a message delivery component for sending advertisement messages to the customers through the communications network 4. The VAS gateway 3 may also include a database and an action-tracking component for monitoring user actions regarding the advertisements.

A billing system 5 represents any real-time billing system or close-to-real-time billing system that may be employed for monitoring the usage of the communication services in the communications network 4. Services, i.e. communication events, may include but are not limited to voice, messaging services (Short Message Service, Multimedia Message Service, Instant Message Service, Electronic mail services), video telephony services, push to talk services, data services such as Internet or Wireless Application Protocol (WAP) browsing services, content usage (television, radio, video) services, download services. The billing system 5 may also refer to any 3^{rd} party offered service running in a server or a computer system, such as a proxy server or a web server that offers services to mobile users. The billing system 5 may receive charging records from other network elements, each charging record comprising all or some of the information required for the billing of a given communication by a user in the communications network, possibly excluding price information. A charging record may specify the content and format of the file that is delivered to the billing system 5. Charging records are often referred to as call detail records (CDRs) or charging data records, or service detail records (SDRs) in value added services. The charging records may include not only the user's calling or originating number/address or similar identity but also a destination of the communication, for example, a called telephone number of a communication, an Uniform Resource Locator (URL) or similar network address accessed via the communication network 4, a telephone number or network address number to which a message is sent, etc. The information can be delivered to the billing system 5 from any communication network element handling a given communication, such as via a short message service center (SMSC) handling SMS messages of a user, a multimedia message service center (MMSC) handling MMS messages of a user, Wireless application protocol gateway (WAP-GW) handling a WAP communications of a user, and an Internet access point (Internet AP), a serving GPRS support node (SGSN), a gateway GPRS support node (GGSN), etc.

In an embodiment of the invention, the billing-system 5 may be used to meter usage of the services. The metered usage of the services may be compared with a free/subsidized balance allocated to each consumer in the communication network. In embodiments of the invention, typically no invoices are sent to consumers but the metered usage may be compared with the business rules associated with customer and metered cost may be invoiced directly or indirectly from advertisers, such the advertiser 1.

The type and format of an advertisement message as well as the delivery method used may be selected among those available in the communication network 4 employed. Such message formats and delivery methods may include but are not limited to messaging services, such as short message service (SMS), multimedia message service (MMS), Instant Message Service (IMS), electronic mail, file downloading or browsing services, such as Wireless application protocol (WAP), Word Wide Web (WWW), audio streaming, video streaming or other data services, etc.

FIG. 2 is a block diagram illustrating a high-level architecture of another exemplary system embodying the concept according to FIG. 4, e.g. a mobile marketing funded cellular virtual operator.

In the exemplary architecture shown in FIG. 2, the communication network 4 may consist of several larger entities, such as a Radio Access Network (RAN) 10, a core network 11, and a back end system 12. A mobile terminal 6A may be connected to the RAN that may comprise several base stations (BSs) 43 and Base Station Controllers (BSCs) 45. The RAN may be connected to the back end system comprising network entities like Mobile Switching Center (MSC) 86, a billing system 5 and a Home Location Register (HLR). For example the speech communications services may be provided through the RAN 10 and the back end system 12. Thus, the back end system 12 may be a GSM core network, for example.

In the exemplary architecture shown in FIG. 2, data services are provided through a different core network 11. In the example illustrated, the core network 11 is implemented as a GPRS (General Packet Radio Service) GPRS core network, but any core network suitable for data communications may be used. The GPRS core network may comprise a Serving GPRS Support Node (SGSN) 80 and a Gateway GPRS Support Node (GGSN) 81, for example. A charging gateway 82 may control the access of a mobile terminal to Internet services, and it may communicate with billing system 5 and also with advertisement system 2. The entities 10, 11 and 12 may be implemented in a GSM network having a GPRS service. However, the division to the RAN and the core networks is utilized especially in the third generation (3G) mobile communications system standards. Moreover, different operators may run different entities shown in FIG. 2.

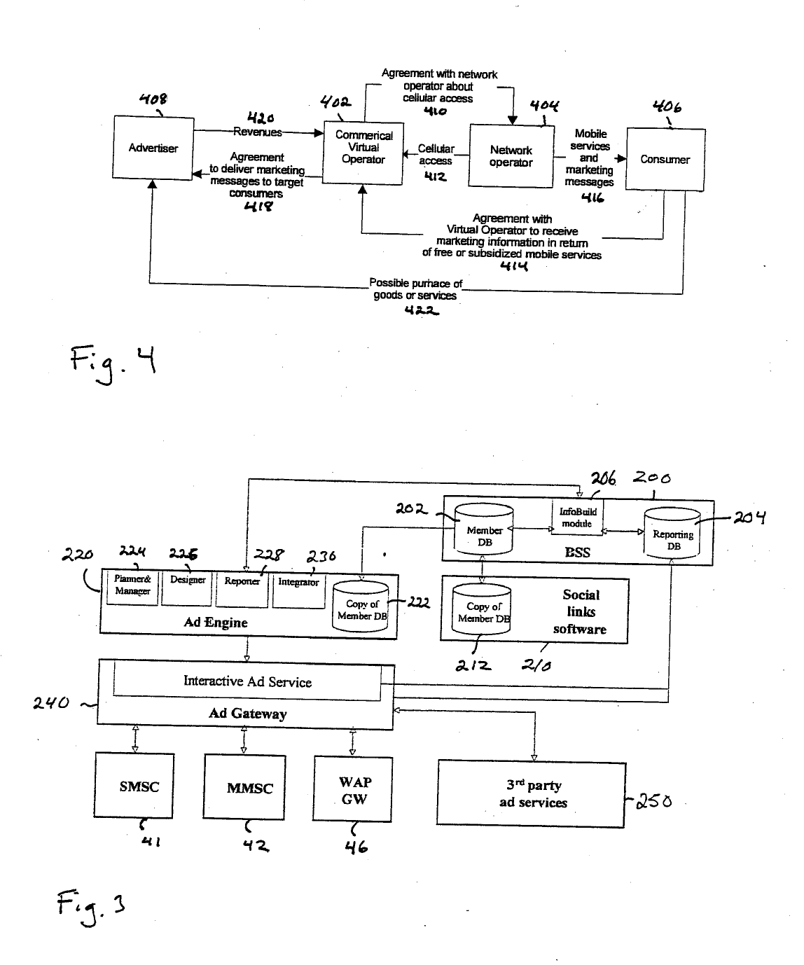

The advertisement system 2 may comprise of databases, computer programs and related hardware which can be used to offer a tool and an interface for the advertisers to reserve, program and define advertisement campaigns, there is also typically an interface to the communication network 4, e.g. via a value added service node, which may be connected to the RAN 10 or the core network 11 or to the Internet 7. The advertisement system 2 may be connected to the RAN 10 or the core network 11 also or alternatively via the Internet 7. A content server 9 may be a web server in the Internet, for example. An example of the advertisement system will be described below with reference to FIG. 3.

One possible business arrangement when building a commercial virtual operator network (CVON) in the system architecture shown in FIG. 2 is to make agreement with an owner or operator of the RAN 10 to lease or rent part of the radio access capacity for business purposes of building a virtual operator. In many cases the RAN 10, the core network 11 and the back end system 12 may be owned and/or controlled by one party, i.e. host network operator. Orange in the United Kingdom (UK) is an example of such an operator.

As one of the core business drivers for the CVON type of business is the information related to consumers, the CVO may preferably lease or hire only the resources of the RAN 10 and the core network 11 from a host operator and operate the back end system 12 and the advertisement system 2 as core parts of the business. In some arrangements, it may be beneficial to lease also the back end system 12 but from a different party than the operator of networks 10 and 11. The advertisement system 2 may preferably be always controlled by the CVO.

The system architecture shown in FIG. 2 may be arranged in such a way that the back end system 12 is not located in a same target market area as that of the actual RAN 10. For example, the RAN 10 and the core network 11 may be leased from a host network operator in the United Kingdom (UK), and there may be leased Internet connection lines to facilities where the back end system 12 is hosted or run in own facilities. The back end system 12 may therefore be in different country or even in different continent than the actual RAN 10 and the related core network 11. Moreover, in addition to that the back end system 12 may be located in a separate geographical area, also the advertisement system 2 may be located in a place different from the locations of the RAN 10, the core network 11 and/or the back end system 12. For the implementation point of view, all the parts of the system architecture shown in FIG. 2 may also be in the same country or area.

As noted above, one part of the CVON operations may include the advertisement management system 2. An exemplary configuration of an advertisement management system 2 and some related entities are shown in FIG. 3. The Business Support System (BSS) 200 may be a computer system in which member (customer) databases 202 and reporting databases 203 may be maintained.

The consumers (users) of the mobile services offered by the CVON may be referred as members, subscribers, users, or consumers. As the CVON operator offers free or subsidized mobile services for the members, the advertisement management system may comprise a database that contains required information on the members, such as profile information that profiles users or members for marketing purposes. In the exemplary system illustrated in FIG. 3, such database is the member database 202. Typically the information may be collected prior to allowing the consumer to join free mobile service. The information may be updated later as the preferences of the member change and/or there is need to collect more information on the members. The information may be updated also automatically as the member or peer group of the member interacts with the advertisement system directly or indirectly. The advertisers may use the member information as they define a target audience for the marketing campaigns using these profiles. The member information may be presented to advertisers in such a format that no direct association can be made between any specific consumer and his/her profile, i.e. the anonymity of the consumers is conserved.

In the member information, at least one of the profiles may comprise one or more of the following pieces of information: a sociological background of a user; age; sex; a target telephone type; an income level; status of a user; a location of a user; historical data of a user's behavior; information of sent direct advertisement to a user; information of content vouchers or coupons sent to a user; codes of vouchers or coupons sent to a user; lifestyle and interest related; behavior; demographics; education; marital status; zip code; preferred times for advertisements.

The advertisement system 2 manages advertising campaigns and its databases may contain all relevant information for the advertisement campaign to be run. For example, the databases may store campaign parameters, such as advertisement messages, a user profile; preferences of when to send messages; to which target group an advertisement is sent; on which format an advertisement is sent; a target price level of an advertisement; a target feedback level of the advertisement; a target audience; demographics of a target audience; a duration of a advertisement campaign, cost per an advertisement; type of an advertisement; a sociological background of a target audience; age; sex; a target telephone type; an income level; status of a user; a location of a user; historical data of a user's behavior; historical data on a behavior of a profile of users; information of sent direct advertisement to a user; information of content vouchers or coupons sent to a user; codes of vouchers or coupons sent to a user; a time of a day or a week or a month or a date, etc. The advertisement system 2 may also be used to maintain rules of the sponsoring communications and/or service access.

The BSS 200 may also include interfaces to software and server systems providing added value information on the profiling of the consumers, such as social links software 210. The social links software may be comprise a copy 212 of the member (consumer) database 202 in the advertisement engine 220. The social links software 210 may be used to analyze relationships between mobile users in order to determine the most attractive consumers for certain messages. There may also be an interface or software module 206 which may offer an interface for advertisers, an advertisement engine or other parties to look, modify, add, extract reports, etc. of the databases in the BSS 200.

The advertisers may be able to connect to the advertisement management system 2 via a web interface using personal computers with a web browser so as to define marketing campaigns and set up the delivery parameters or by a special application. For example, the advertisement engine 220 can provide a web type of interface to advertisers to plan and manage (Planner and manager block 224), design (Designer block 226), make and receiver reports (Reporter block 228) of the advertisements and campaigns which they have or will have running in the advertisement system. The advertisement engine may also contain other interfaces, such as an interface to the BSS 200 and an Integrator interface 230 to add more function blocks in the future. There may also be a copy 222 of the member (consumer) database 202 in the advertisement engine 220.

The advertisement engine 202 may be configured for programming the advertisement gateway 240 (such as VAS GW 3 in FIG. 1), e.g. in a patch type of fashion, to run advertisement campaigns. The campaigns may be run, i.e. messages to the consumers can be delivered via multiple channels, such as the SMSC 41, MMSC 42, and the WAP gateway 46. There may also be an interface to other 3^{rd} party advertisement services 250, such as banner advertisements or sending of SMS messages by a 3^{rd} party to the CVON consumers (members).

The techniques described herein may be implemented by various means. For example, these techniques may be implemented in hardware (one or more devices), firmware (one or more devices), software (one or more modules), or combinations thereof. For a firmware or software, implementation can be through modules (e.g., procedures, functions, and so on) that perform the functions described herein. The software codes may be stored in any suitable, processor/computer-readable data storage medium(s) or memory unit(s) and executed by one or more processors/computers. The data storage medium or the memory unit may be implemented within the processor/computer or external to the processor/computer, in which case it can be communicatively coupled to the processor/computer via various means as is known in the art. Additionally, components of systems described herein may be rearranged and/or complimented by additional components in order to facilitate achieving the various aspects, goals, advantages, etc., described with regard thereto, and are not limited to the precise configurations set forth in a given figure, as will be appreciated by one skilled in the art.

It will be obvious to a person skilled in the art that the inventive concept can be implemented in various ways. The invention and its embodiments are not limited to the examples described above but modifications and changes can be made without departing from the scope of the attached claims.

1. A method for providing mobile communications services, comprising:
making a subscription agreement between a service provider and a plurality of users on free or subsidized mobile communications services,
collecting a user profile for each of said plurality of users, each user profile profiling a user for marketing purposes,
making an agreement between the service provider and at least one advertiser on delivering advertisement messages,
selecting target users for said advertisement messages among said plurality of users based on said collected user profiles,
delivering said advertisement messages to said target users through a mobile communications network,
providing said target users with free or subsidized mobile communications services in the mobile communications network as a reward for receiving and/or reacting to said advertisement messages,
financing the service operator by revenues from the at least one advertiser.

2. A method as claimed in claim 1, further comprising providing said target users with free or subsidized mobile communications services in the mobile communications network as a reward before, during and/or after said target users receive and/or react to said advertisement messages.

3. A method as claimed in claim 1, further comprising:
making an agreement between the service provider and a network operator operating the mobile communications network on using the mobile communications network for providing the mobile communications services for said plurality of users.

4. A method as claimed in claim 1, further comprising:
paying said service operator for the free or subsidized mobile communications services provided to said plurality of users.

5. A method as claimed in claim 1, further comprising operating the mobile communications network by the service provider.

6. A method as claimed in claim 1, further comprising configuring a billing system of the mobile communications system not to bill said target users for the provided free or subsidized mobile communications services.

7. A method as claimed in claim 1, further comprising:
configuring a billing system of the mobile communications system to bill the service operator for the provided free or subsidized mobile communications services.

8. A method as claimed in claim 1, wherein said subscription agreement includes terms and conditions to be fulfilled by the user regarding reception of advertisement messages in order to obtain free or free of subsidized mobile communications services.

9. A method as claimed in claim 8, wherein said terms and conditions include one or more of a number of advertisements which must be received by a user within a predetermined period of time and advertisement messages which must be replied to by the user.

10. A method as claimed in claim 1, wherein said subscription agreement defines the amount of free or subsidized mobile communications services to be provided to a user when the terms and conditions are fulfilled by the user.

11. A method as claimed claim 1, wherein the advertisement messages comprise one or more message types comprising at least one of: multimedia message service based advertisements; short message service based advertisements; message tagging based advertisements; wireless application protocol based push advertisements; banner advertisements; search related advertisements; interactive advertisements; video advertisements; audio advertisements.

12. A mobile communications service provider system, comprising:
a database configured to store a user profile for each of a plurality of users having a subscription agreement with a service provider and a plurality of users on free or subsidized mobile communications services, each user profile profiling a user for marketing purposes,
an advertisement management unit configured to manage advertisement messages or campaigns according to an agreement made between the service provider and at least one advertiser on delivering advertisement messages, revenues from the at least one advertiser financing the operation of the mobile communications service provider system,
an advertisement gateway configured to deliver advertisement messages through a mobile communications network to target users selected for said advertisement messages among said plurality of users based on said collected user profiles, and
a billing system configured to provide said target users with free or subsidized mobile communications services in the mobile communications network as a reward for receiving and/or reacting to said advertisement messages.

13. A system as claimed in claim 12, wherein said billing system is configured to provide said target users with free or subsidized mobile communications services in the mobile communications network as a reward before, during and/or after said target users receive and/or react to said advertisement messages.

14. A system as claimed in claim 12, further comprising an advertiser self-service interface through which the at least one advertiser is capable of creating and managing advertisement messages and advertisement campaigns.

15. A system as claimed in claim 12, further comprising a further interface for receiving advertisement messages sent from third parties to be forwarded to said plurality of users by the service provider.

16. A system as claimed in any claim 12, wherein a network operator of said mobile communications network is a different from the service provider, the network operator and the service operator having an agreement on using the mobile communications network for providing the mobile communications services for said plurality of users by the service provider.

17. A system as claimed in claim 12, wherein the service provider is also a network operator of the mobile communications net-work.

18. A system as claimed in claim 12, wherein the free or subsidized mobile communication comprises one or more of speech communication, data communication and messaging.

19. A system as claimed in claim 12, wherein the free or subsidized mobile communication is related to at least one of following services; a web page, a browsing, a file download, a video download, a picture download, a music download, a document download, a streaming service, audio streaming, video streaming, a video service, a music service, and any other digital content or service which can be accessed through a communications system.

20. A system as claimed in claim 12, wherein at least one of said user profiles comprises at least one of: a sociological back-ground of a user; age; sex; a target telephone type; an income level; status of a user; a location of a user; historical data of a user's behavior; information of sent direct advertisement to a user; information of content vouchers or coupons sent to a user; codes of vouchers or coupons sent to a user; lifestyle and interest related; behavior; demographics; education; marital status; zip code; preferred times for advertisements.

21. A system as claimed in claim 12, wherein at least one or more of the following pieces of information is used in the selection of said target users for an advertisement message: a user profile; preferences of when to send messages; to which target group an advertisement is sent; on which format an advertisement is sent; a target price level of an advertisement; a target feedback level of the advertisement; a target audience; demographics of a target audience; a duration of a advertisement campaign, cost per an adver-tisement; type of an advertisement; a sociological background of a target audience; age; sex; a target telephone type; an income level; status of a user; a location of a user; historical data of a user's behavior; historical data on a behavior of a profile of users; information of sent direct advertisement to a user; information of content vouchers or coupons sent to a user; codes of vouchers or coupons sent to a user; a time of a day or a week or a month or a date.

22. A computer program resident on computer readable media and being arranged to:
store a user profile for each of a plurality of users having a subscription agreement between a service provider and a plurality of users of free or subsidized mobile communications services, each user profile profiling a user for marketing purposes,
manage advertisement messages or campaigns according to an agreement made between the service provider and at least one advertiser on delivering advertisement messages, revenues from the at least one advertiser financing the operation of the mobile communications service provider system,
deliver advertisement messages through a mobile communications network to target users selected for said advertisement messages among said plurality of users based on said collected user profiles, and
provide said target users with free or subsidized mobile communications services in the mobile communications network as a reward for receiving and/or reacting to said advertisement messages.

23. A mobile communications service provider system, comprising:
means for storing a user profile for each of a plurality of users having a subscription agreement between a service provider and a plurality of users of free or subsidized mobile communications services, each user profile profiling a user for marketing purposes,
means for managing advertisement messages or campaigns according to an agreement made between the service provider and at least one advertiser on delivering advertisement. messages, revenues from the at least one advertiser financing the operation of the mobile communications service provider system,
means for delivering advertisement messages through a mobile communications network to target users selected for said advertisement messages among said plurality of users based on said collected user profiles, and
means for providing said target users with free or subsidized mobile communications services in the mobile communications network as a reward for receiving and/or reacting to said advertisement messages.

24. A system as claimed in claim 23, wherein said means for providing provides said target users with free or subsidized mobile communications services in the mobile communications network as a reward before, during and/or after said target users receive and/or react to said advertisement messages.
